(19) United States
(12) Patent Application Publication
(10) Pub. No.: US 2012/0233697 A1
(43) Pub. Date: Sep. 13, 2012

(54) Method and Apparatus Reducing Malware Detection Induced Delay

(75) Inventors: Vladimir Katardjiev, Uppsala (SE); Göran Eriksson, Norrtalje (SE)

(73) Assignee: TELEFONAKTIEBOLAGET L M ERICSSON (PUBL), Stockholm (SE)

(21) Appl. No.: 13/505,882

(22) PCT Filed: Nov. 6, 2009
(86) PCT No.: PCT/SE2009/051269

§ 371 Date: May 3, 2012

(51) Int. Cl. G06F 21/00

(52) U.S. Cl. 726/24

(57) ABSTRACT

Methods and apparatuses for network 10 based malware detection in an interrelated autonomous network access module 120 and network proxy 220 pair, where the network access module 120 is comprised within a mobile device 100. A file request from an end-user to the network 10 is intercepted, and a request is then sent both to a remote web server 30 and to a malware scanner server 30. When the malware scanning is finished, a notification is sent to the network access module 120, who have then received most or all fo the requested file. The network access module 120 then manages the mobile device's 100 access to the file contingent upon the nature of

### TECHNICAL FIELD

The present invention relates to network-based malware detection during wireless streaming.

### BACKGROUND

With increasing popularity of content streaming services such as YouTube and Spotify, the number of users in the mobile space is increasing, along with the general traffic load. The incumbent user population consists of the early adopters who are now expecting their mobile devices to handle download faster than before with maintained quality and security, and of an experienced majority of desktop users who have high expectations of what the user experience should be on a mobile device.

However, wireless data transmission adds new problems to the task of streaming data. One problem is the simple fact that wireless data streaming is slower than wired streaming. Although a small problem for small files and notifications, it grows into a very big problem when streaming large files, such as a high definition feature film. Using a simile, it is like drinking water from a very narrow drinking straw. If it is a small glass of water, the difference between gulping directly from the glass and using the thin straw is negligible. But if you are drinking a whole pitcher, it will make a difference time-wise.

A second problem is that the introduction of wireless communications paths also dramatically increases the vulnerability for man-in-the-middle attacks. The wireless path facilitates interception of messages going between two communicating devices, and injection of new ones, thereby impersonating one or both of the mobile devices.

At times, the content desired for download contains malicious code, malware, such as viruses, keyloggers or other software designed to commandeer control of the computing resources of an end-user device. The malware can then perform tasks to various degrees of severity; from merely obstructing device operation, to stealing sensitive information and disrupting network activity. Combating malware is thus desirable, not only for end-users but also for network operators wishing to reduce network disruption.

Detecting and removing malware is standard practice on desktop computers. The malware is analyzed and a hashcode characterizing it is generated and implemented in malware scanning software. When a user clicks on a download link, the web browser downloads the complete file to the local computer. The malware scanning software installed on the same computer then searches the file for hashcodes indicative of malware. If found, the malware is being removed, after which the user can open the file. Similarly, firewalls and servers, such as mail servers, download the entire file locally and check it for malware before making it available to the requesting machine. This principle, called sandboxing, works satisfactory in devices/machines with adequate local access to processing and memory capacity. However, size, and therefore processing and memory capacity, of a mobile device is defined, and confined, by the mobility requirement, and consequently sandboxing is not a viable solution. This is a third problem.

The algorithmic hashing solutions referred to above operate on files in their entirety. Accordingly, the entire file must be downloaded before any malware scanning can commence. Using the drinking metaphor again you must wait until the pitcher is full before you can start drinking, you cannot drink while the pitcher is being filled. The hash-code detection is in itself a computationally intensive and time-consuming operation, and to that comes the time it takes to deliver the content to the requesting end-user or application. This is a fourth problem. In addition there is a risk that the downloading agent, e.g. a web browser in a mobile phone, attempts to not only download, but also to execute the downloaded data on-the-sly. This is a fifth problem.

When a network-based proxy performs the malware detection, this on-the-sly risk is eliminated or at least reduced compared to when the browser is sandboxing. The time-consumption however, remains the same - time for streaming from content server to malware scanner server plus scanning time plus streaming from malware server to requesting entity. For a requesting mobile device connected via radio link, the total delivery time is substantial.

### SUMMARY

It is the object to obviate at least some of the above described inter-related disadvantages and provide an appropriate set of improved inter-related methods, apparatuses and computer media products avoiding the above mentioned drawbacks.

A first aspect of the invention comprises a first method for network based malware detection in an autonomous network access module. This method is interrelated with a first method for network based malware detection in a network proxy described below.
The network access module is comprising a local storage, and providing radio connectivity to a mobile device. The first method is comprising the steps receiving and intercepting a file request to the network from the mobile device;
reserving space on the local storage for the requested file;
instructing a network proxy to request streaming of the file from a remote web server on behalf of the network access module;
instructing the network proxy to concurrently stream the file to the network access module and to a malware scanning server in the network;
receiving from the network proxy, and storing in the local storage, streamed file fragments as they arrive;
awaiting a notification based on the outcome of the malware scanner server scanning the file; and
managing mobile device access to the partly or completely downloaded file contingent upon the received notification.

As mentioned, the first aspect of the invention also comprises a method for network based malware detection in a network proxy for the autonomous network access module. The method is comprising the steps requesting streaming of the file from a remote web server on behalf of the network access module upon instruction from a network access module;
concurrently streaming the file to the network access module and to a malware scanning server upon instruction from the network access module; and
arranging for the network access module to receive a notification based on the outcome of a malware scanner server scanning the file.

A second aspect of the invention is a second method for network based
malware detection in a network proxy. This method is interrelated with a second method, described below, for network based malware detection in a network access module. The autonomous network access module is comprising a local storage, and providing radio connectivity to a mobile device. The method is comprising the steps receiving and intercepting a file request to the network from the mobile device; instructing the network access module to reserve space on the local storage for the requested file;
requesting streaming of the file from a remote web server on behalf of the network access module of the mobile device;
concurrently streaming the received streamed file to the network access module and to a malware scanning server on behalf of the network access module;
arranging for the network access module to receive a notification based on the outcome of the malware scanning server scanning the file; and
arranging for managing the mobile device access to the partly or completely downloaded file contingent upon the received notification.

As mentioned the second aspect also comprises a second method for network based malware detection in the autonomous access module. As mentioned the network access module is comprising a local storage, and providing radio connectivity to a mobile device. The method is comprising the steps
receiving and forwarding a file request from the mobile device;
reserving space on the local storage of the network access module for the requested file upon instruction from the network proxy;
receiving from the network proxy, and storing in the local storage, streamed file fragments as they arrive
awaiting a notification based on the outcome of a malware scanning server scanning the file; and
managing the mobile device access to the partly or completely downloaded file contingent upon the received notification.

The first aspect is involving a usage of the network access module as an initiator, and the network proxy as a responder. The second aspect involves a usage of the network proxy as the initiator and the network access module as the responder.

### BRIEF DESCRIPTION OF THE DRAWINGS

In order to explain the invention in more detail an embodiment will be described in detail below, reference being made to the accompanying drawings, in which

FIG. 1 is an overview of the system in which embodiments of the invention are implemented.

FIG. 2 is a schematic illustration of an inter-related network access module 120 and network proxy 220

FIG. 3 is a schematic illustration of an inter-related network access module 320 and network proxy 420

FIG. 4 is a flow-chart overview of alternative methods in a network access module

FIG. 5 is a flow-chart overview of alternative methods in a network proxy.

### DETAILED DESCRIPTION

The five problems identified above all cause negative effects in their own right. Unfortunately, the factors causing the problems are intricately intertwined, making it difficult to mitigate one problem without automatically aggravating several or all of the other problems. Together they cause lengthy downloading, uncertain integrity and unsafe operation. This cluster of problems is cleverly solved by embodiments of the present invention.

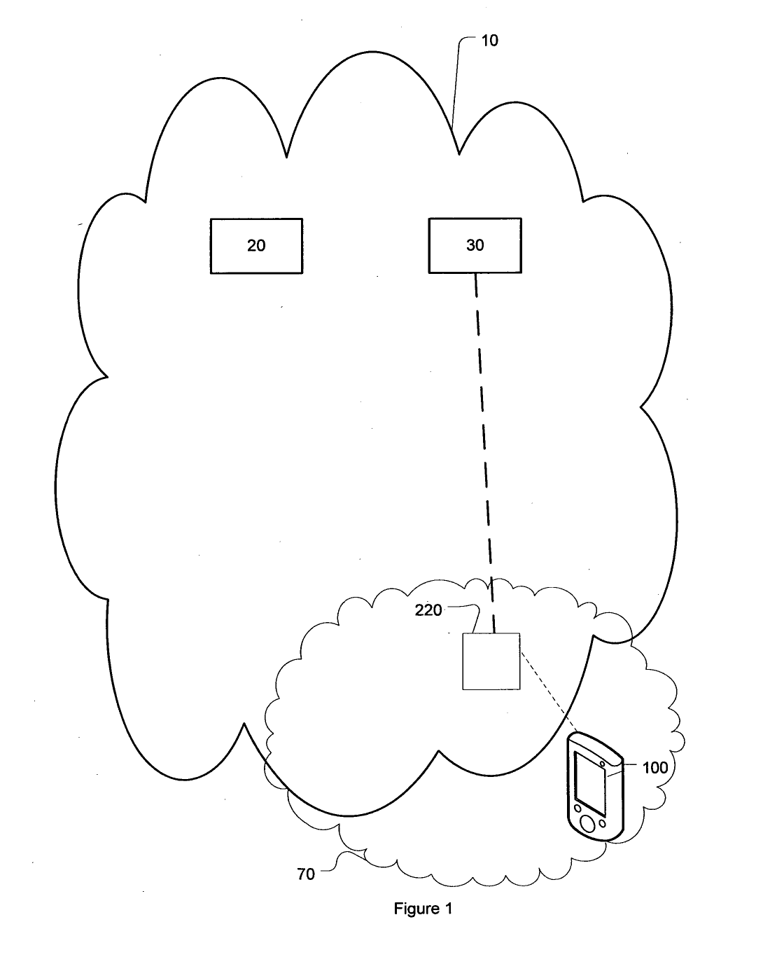

Embodiments of the invention can be implemented in a system as described in FIG. 1. The system comprises a mobile device 100, comprising a network access module 120 providing radio network 70 connectivity. The system also comprises a network proxy 220 connected both to the network 10 and the radio network 70, a remote web server 30 and a malware scanning server 20. These nodes interact in a network 10.

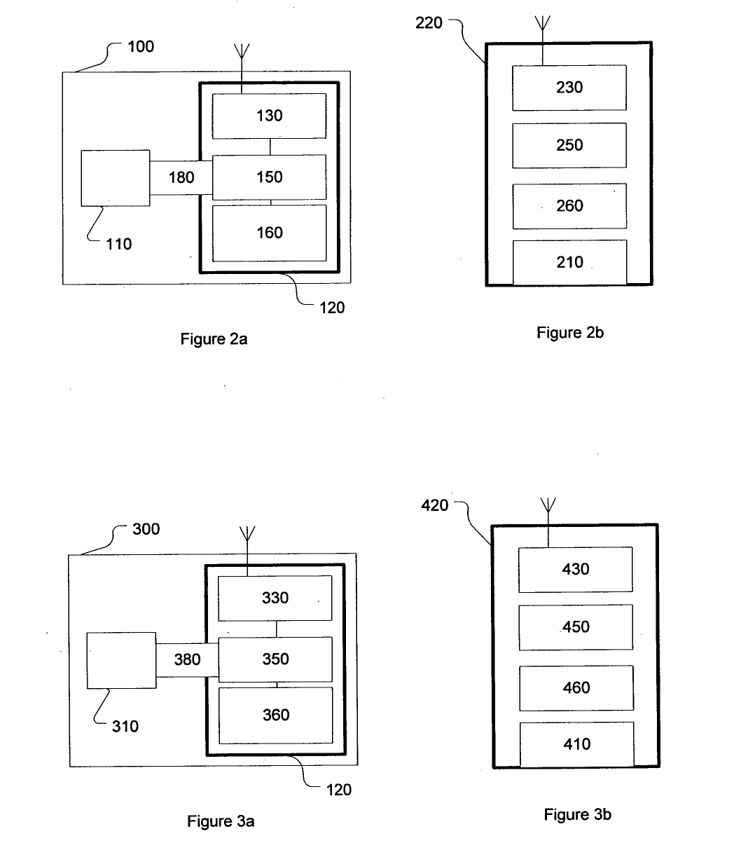

A network access module 120 will now be described in relation to FIG. 2a.

FIG. 2a displays a mobile device 100, such as for instance a mobile phone. The mobile device comprises a main processing unit 110, a user interface 140 and a network access module 120 adapted to provide network connectivity to the mobile device 100. The network access module 120 comprises a radio transceiver 130, a processing unit 150 and a local storage 160. The local storage 160 has a larger capacity compared to conventional local storages, and is adapted to provide intermediate data storage within the network access module 120. Further, a data bus 180 constitutes the interface between the network access module 120 and the mobile device. The local storage 160 has a larger capacity compared to conventional network access modules, and is adapted to provide storage for file caching within the network access module 120. Further, a data bus 180 constitutes the interface between the network access module 120 and the mobile device 100. Because of the bus 180, any resource request from the mobile device 100 must be processed by the network access module's 120 processing unit 150, even for resources available within the local storage 160. The bus interface 180 hence entails a natural isolation of the network access module 120 from the mobile device 100, and the network access module 120 can therefore autonomously manage the mobile devices 100 access to data stored in the local storage 160. This autonomy makes it possible for the network operator to have a considerable level of trust for the network access module 120, and to consider the local storage 120 to be a secure place caching, even though the mobile device 100 may not be trusted to refrain from trying to access untrusted files.

An interrelated network proxy 220 will now be described in relation to FIG. 2b. The network proxy 220 comprises a first radio network interface and transceiver 230, a second network interface 210 towards the Internet, a memory 260 and a processing unit 250. Via the first interface 230, it is adapted to communicate with the network access module 120. Via the second interface 210 it is adapted to communicate with a remote web server, a malware scanning server and other nodes in the system, such as authority providers etc., and to receive instructions from the network operator The network proxy 220 is further adapted to give or forward from the network operator instructions to the network access module 1200. The network proxy 220 is further adapted to manage certificates. The network access module 120 and the network proxy 220 are trusted by the network operator.

FIG. 3a analogously displays a mobile device 300, a processing unit 310, a user interface 340 and a network access module 320. The network access module 320 comprises a radio transceiver 330, a processing unit 350 and a local storage 360. FIG. 3b shows a network proxy 420 comprising first and second interfaces 410, 430, a memory 460 and a processing unit 450. These components are arranged in analogy with the components displayed in FIG. 2, and configured and adapted in a related way.

In the core of the inventive concept is the interdependent access module 120; 320/proxy 220; 420 pair acting as an intermediate between the network 10 and the final receiver—the mobile device 100; 300. The interdependent access module 120;320/proxy 220;420 pair is an emulsifier of wireless and wired, enabling fast, secure content delivery with maintained integrity to a wireless mobile device 100;300 in a way that was previously the privilege of larger more advanced wired devices.

When a mobile device 100; 300 with a compatible network access module 120;320 connects to a network 10, a service in the network is informed of the network access module's existence and the amount of memory storage available, as well as the data stored in the network access module's local storage.

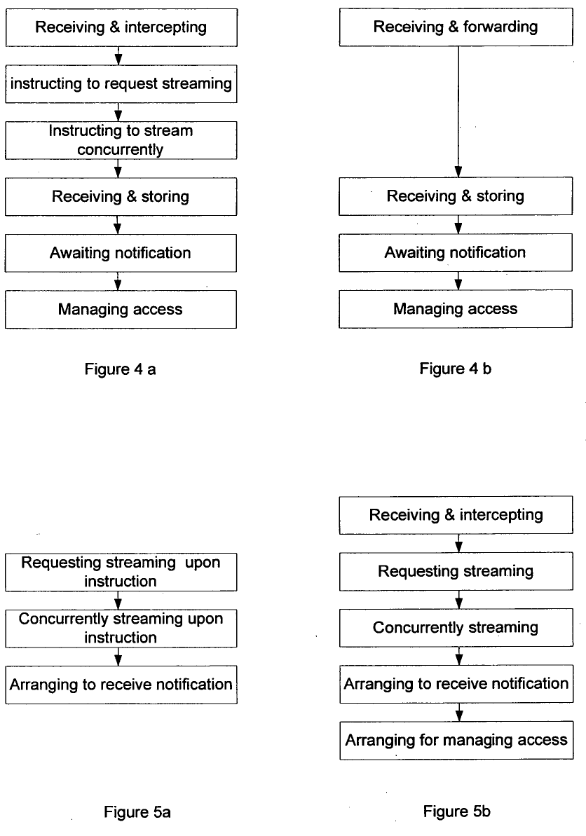

A detailed description of a method according to one embodiment of the invention will now be given in relation to FIGS. 4a and 5a. This embodiment is involving the usage of the network access module 120 as an initiator, and the network proxy 220 as a responder executing certain instructions from the network access module.

FIG. 4a shows that when the mobile device 100 is requesting a file from the network 10, the request is transferred via the bus 180 where the network access module 120 is receiving it.

The network access module is then intercepting the file request to the network 10 from the mobile device 100. This is possible because of the autonomous properties of the network access module. The interception may be a consequence of a decision taken based on assumptions about server trustworthiness, etc., or it may be a default step. The network access module is then instructing a network proxy 220 to request streaming of the file from a remote web server 30 on behalf of the network access module 120. Thereafter, the network access module is instructing the network proxy 220 to stream the file to the network access module 120 and also concurrently stream to a malware scanning server 20 in the network 10;

At some point, the network access module may be reserving space on the local storage 160 for the requested file, so that it is available as the file fragments begin to arrive. receiving from the network proxy 220, and storing in the local storage 160, streamed file fragments as they arrive. It is also concurrently awaiting a notification based on the outcome of the malware scanner server 20 scanning the file.

When this notification is arriving, the network access module can start managing mobile device 100 access to the partly or completely downloaded file contingent upon the received notification.

A method from the network proxy's point of view will now be described in relation to FIG. 5a. The method begins with the network proxy 220 receiving an instruction from the network access module 120, which it executes, i.e., the network proxy 220 is requesting streaming of the file from a remote web server 30 on behalf of the network access module 120 upon instruction from a network access module 129. The network proxy 220 is also concurrently streaming the file to the network access module 120 and to a malware scanning server 20 upon instruction from the network access module 129. As the malware scanning server 20 is a server on the network 10 , its bandwidth is greater than that of the network access module 120 and thus the malware scanning server 20 will have access to the file in its entirety sooner than network access module will 120. This step enables scanning of the file to commence sooner that it otherwise would have.

Lastly it is arranging for the network access module 120 to receive a notification based on the outcome of a malware scanner server 20 scanning the file.

A detailed description according to one embodiment of the invention will now be given in relation to FIGS. 4b and 5b. This embodiment is involving the usage of the network proxy 320 as an initiator, and the network access module 320 as a responder executing certain instructions from the network proxy.

A method will now be described in relation to FIG. 5b, in which the network proxy 320 is receiving and intercepting a file request to the network 10 from the mobile device 300. Subsequently, the network proxy 320 is requesting streaming of the file from a remote web server 30 on behalf of the network access module 320. This means that to the remote web server 30 the network access module 320 will appear to be the original source of the request.

The network proxy 420 may at some point be instructing the network access module 320 to reserve space on the local storage 360 for the requested file.

When the network proxy is starting to receive the streamed file from the remove web server, it is concurrently streaming it forward to the network access module 320, but also to a malware scanning server 30, still on behalf of the network access module 320. The network proxy 420 is then arranging for the network access module 320 to receive a notification based on the outcome of the malware scanning server 20 scanning the file. Lastly, the network proxy 420 is arranging for managing the mobile device 300 access to the partly or completely downloaded file contingent upon the received notification.

A method will now be described in relation to FIG. 4b, in which the network access module 320 is
receiving and forwarding a file request from the mobile device 300;
reserving space on the local storage 360 of the network access module 320 for the requested file upon instruction from the network proxy 420;
receiving from the network proxy 420, and storing in the local storage 360, streamed file fragments as they arrive
awaiting notification based on the outcome of a malware scanning server 40 scanning the file; and managing the mobile device 300 access to the partly or completely downloaded file contingent upon the received notification.

According to certain embodiments the arranging to receive step may comprise the network proxy 220; 420 sending the malware scanning server 20 address and signing details to the network access module 120; 320 thus enabling it to receive a notification directly from the malware scanning server 20. This is possible because the network proxy 220; 420 is a trusted node, and because the autonomy of the network access module 120; 320 granted by the bus interface 180, makes it trusted as well.

The concurrently streaming step may then further comprise instructing malware scanning server 20 to notify the network access module 120; 320 directly.

The awaiting notification may then comprise the steps Receiving, in the network access module 120; 320, address and signing information. This step is enabling direct receipt of the notification from the malware scanning server 20. Upon receipt of a malware absence notification, the managing access step may further comprise granting the mobile device 100; 300 access to the file stored in the local storage 160; 360.

Upon receipt of a malware presence notification the managing access step may comprise denying the mobile device 100; 300 access to the file.

Upon receipt of a malware presence notification the managing access step may further comprise refusing further reception of file fragments, and or deleting file fragments stored in the local storage 160; 360. In conjunction with the MSS sending a malware presence notification, the network operator may be informed of the identity of the malware infected file e.g. the URI, which enables the operator to take measures to removing copies of the file in other parts of the network 10.

According to inter-related methods, the awaiting a notification step may further comprise the network access module 120; 320 receiving address and signing information of the malware scanning server 40.

Upon receipt of a malware absence notification, the managing access step may then comprise granting the mobile device 100; 300 access to the file stored in the local storage 160; 360. Upon receipt of a malware presence notification the managing access step may further comprise denying the mobile device 100; 300 access to the file. If streaming of the file is still ongoing, further reception of file fragments may be refused. Upon discretion of the network operator, which will have been informed of presence of malware, file fragments already stored may be destroyed. These inter-related methods eliminate the risk for man-in-the-middle attacks between the network access module 120; 320 and the malware scanning server 30.

According to other embodiments a method may comprise receiving a first notification from the malware scanning server 20. The arranging for managing step may comprise the network proxy 220; 420 sending a second notification contingent upon the first notification to the network access module 120; 320, the second notification comprising instructions to be executed during the managing access step.

The awaiting step may comprise receiving from the network proxy 220; 420 a second notification contingent upon the first notification to the network access module 120; 320, the second notification comprising instructions to be executed during the managing access step.

Upon receipt of a malware absence notification, the second notification may comprise instructions to grant the mobile device 100 access to the file stored in the local storage 160; 360.

Upon receipt of a malware presence notification, the second notification may comprise instructions to deny the mobile device 100; 300 access to the file. It may further comprise refusing further reception of file fragments, and or deleting file fragments stored in the local storage 160; 360. Because all communication in this embodiment passes via the network proxy, which is a trusted node, the risk of man-in-the-middle attack is eliminated here as well.

According to an embodiment of the invention, an interrelated network access module (120) comprised within a mobile device (100), and comprising a local storage (160), a radio transceiver (130) and a processing unit (150), connected to the mobile device (100) via a bus interface (180), is adapted and configured to receive and intercept a file request to the network (10) from the mobile device (100); instruct a network proxy (220) to request streaming of the file from a remote web server (30) on behalf of the network access module (120);
instruct the network proxy (220) to concurrently stream the file to the network access module (120) and to a malware scanning server (20) in the network (10);
receive from the network proxy (220), and storing in the local storage (160), streamed file fragments as they arrive;
await a notification based on the outcome of the malware scanner server (20) scanning the file; and
manage mobile device (100) access to the partly or completely downloaded file contingent upon the received notification.

According to an embodiment an interrelated network proxy (220) for an autonomous network access module (120) comprising a first radio network interface and transceiver (230), a second network interface (210) towards the Internet, a memory (260) and a processing unit (250) is adapted an configured to request streaming of the file from a remote web server (30) on behalf of the network access module (120) upon instruction from a network access module (129); concurrently stream the file to the network access module (120) and to a malware scanning server (20) upon instruction from the network access module (129); and arrange for the network access module (120) to receive a notification based on the outcome of a malware scanner server (20) scanning the file. Further these respective apparatuses (120; 220; 320; 420) can be configured and adapted for all respective methods described above.

One embodiment of the invention is a computer program comprising code means for performing the steps of any one of the methods described above when the program is run on a computer.

One embodiment is a computer program product comprising program code means stored on a computer readable medium for performing the method of any of the claims 1-12, when said product is run on a computer.

An important part of the solution is the concurrent streaming of the requested file to the malware scanning server 30 for scanning, and to the network access module 120; 320 of the requesting mobile device 10; 30 for downloading. As the network access module 120; 320 is connected over radio link, streaming to the network access module 120; 320 is slower than streaming to the malware scanning server 30. The malware scanning server 30 will therefore receive the file in its entirety sooner than the network access module 120; 320 will, and consequently, the malware scanning can start sooner than it would have, had the scanning been performed in the network access module 120; 320 and the result is faster and more reliable. At the same time, once the scanning is executed, a single notification, which is fast even over radio, is sent to the network access module 120; 320 Unlike malware scanning, starting the consumption of a file does not require the file in its entirety. Therefore, upon notification receipt, the network access module 120; 320 immediately grants the mobile device access to the file. For most situations, this method eliminates the delay caused by malware scanning completely, and this is a distinct advantage. Another advantage is that because of the inherent autonomy that the network access module 120; 320 has towards the mobile device there is no risk that the mobile device accidentally opens the file. The network access module 120; 320 constitutes a lock for the downloaded content. Further, due to the introduction of a network proxy 220; 420 in the network that administers certificates . . . , the risk for a man-in-the-middle-attack is considerably reduced, increasing system integrity and safety for the end user. The invention enables safe destruction of files containing malware stored in the local memory 160; 360 of the requesting network access module 120; 320 But the combination of the autonomous network access module 120; 320 and the network proxy 220; 420 also enables increased safety from malware for other mobile devices 100; 300 in the network. Upon detection of malware in a file, the network operator can remove copies of the file not only on servers in the network, but also on other network access module 120; 320 . The invention thus gives the advantage of increased safety for one single network access module's 120; 320 particular request, and at the same time increased access rate of mobile devices in the distributed network. Fewer infected files remaining in the network means less times a mobile device is not granted access to a requested file which in turn increased QoS.

With this method for network-based malware scanning of a wireless content stream, the wireless streaming seizes to be a bottleneck. Unlike hashing algorithm based malware scanners, a streaming client can consume a file while it is downloading, after only a few seconds of buffering. In previously known solutions where malware scanning was made locally, this appealing feature could not be utilized.

The high capacity of a network based malware scanner is maintained and substantially reduces the time that the end-user has to wait to start consuming the content. In order to solve the on-the-sly problem, the methods also utilize the autonomous properties of the network access module 120; 320 caused by the bus interface. Every file request from mobile device is intercepted and replaced by a request on behalf of network access module 120; 320. The network access module 120; 320 then only grants the mobile device 100; 300 to access the received file if the malware scanning server 30 did not find malware in the file.

The invention reduces, or completely eliminates, the delay of malware scanning and elimination, without compromising the security of the procedure. Possibly, security is even increased as the potential malware quarantine is more secure than it would be in a traditional solution.

The time elimination is enabled by the fact that the malware scanning server is not scanning the same copy of the file that is being streamed to the network access module 120; 320. This enables parallel scanning and streaming, which was previously not possible. Since it is done in parallel, the scanning does not introduce any delay that would not be present without the malware scanning. If malware is found, the file that was being streamed to the network access module 120; 320 can be discarded in complete safety, even before the streaming has completed. If no malware is found, the mobile device is given access to the file, again potentially before the streaming of the file has completed, thus adding no overhead time to ensure the safety of the data. In addition, by performing the computationally intensive process on a network-based server side instead of a potentially battery-powered client, this reduces the strain on the mobile device's battery. This is in addition to the processing time saved compared to having the comparatively slower mobile device processor performing the malware scanning.

The invention also poses malware scanning as a managed service. This means that the malware scanning methods, practices and information can be maintained by the network operator, ensuring they always are composed of the latest and most effective means to combat malware.

1.-26. (canceled)

27. A method for network-based malware detection in an autonomous network access module that comprises a local storage and a processing unit, and that provides radio connectivity to a mobile device, wherein the method comprises:
receiving and intercepting, from a main processing unit comprised in the mobile device, a request to a network for a file;
instructing a network proxy to request streaming of the file from a remote web server on behalf of the network access module;
instructing the network proxy to concurrently stream the file to the network access module and to a malware scanning server in the network;
receiving streamed file fragments from the network proxy and storing the fragments in the local storage as the fragments arrive, wherein the local storage is connected to the mobile device via a bus interface;
awaiting a notification based on an outcome of the malware scanner server scanning the file; and
managing access by the mobile device over said bus interface to the partly or completely downloaded file contingent upon the notification.

28. The method according to claim 27, wherein said awaiting further comprises receiving address and signing information that enables direct receipt of the notification from the malware scanning server.

29. The method according to claim 28, wherein, upon receipt of a malware absence notification, managing access by the mobile device further comprises granting the mobile device access to the file stored in the local storage.

30. The method according to claim 28, wherein, upon receipt of a malware presence notification, managing access by the mobile device further comprises denying the mobile device access to the file.

31. The method according to claim 27, wherein said awaiting comprising receiving from the network proxy a second notification contingent upon a first notification to the network access module, the second notification comprising instructions to be executed for managing access by the mobile device.

32. The method according to claim 31, wherein, upon receipt of a malware absence notification, the second notification comprises instructions to grant the mobile device access to the file stored in the local storage.

33. The method according to claim 31, wherein, upon receipt of a malware presence notification, the second notification comprises instructions to deny the mobile device access to the file.

34. A method for network-based malware detection in a network proxy for an autonomous network access module that comprises a local storage and a processing unit, and that provides radio connectivity to a mobile device connected to the local storage via a bus interface, wherein the method comprises:
receiving and intercepting, from a main processing unit comprised in the mobile device, a request to a network for a file;
requesting streaming of the file from a remote web server on behalf of the network access module of the mobile device;
concurrently streaming the received streamed file to the network access module and to a malware scanning server on behalf of the network access module;
arranging for the network access module to receive a notification based on an outcome of the malware scanning server scanning the file; and
arranging for managing access by the mobile device to the partly or completely downloaded file contingent upon the received notification.

35. The method according to claim 34, wherein arranging for the network access module to receive the notification comprises sending a malware scanning server address and signing details to the network access module to thereby enable the network access module to receive a notification directly from the malware scanning server, and wherein said concurrently streaming further comprises instructing the malware scanning server to notify the network access module directly.

36. The method according to claim 34, wherein arranging for the network access module to receive the notification comprises receiving a first notification from the malware scanning server, and wherein arranging for managing access by the mobile device comprises sending a second notification contingent upon the first notification to the network access module, the second notification comprising instructions to be executed for managing access by the mobile device.

37. A method for network-based malware detection in an autonomous network access module that comprises a local storage and a processing unit, and that provides radio connectivity to a mobile device, wherein the method comprises:
receiving a request for a file from a main processing unit comprised in the mobile device and forwarding the request;
while awaiting a notification based on an outcome of a malware scanning server scanning the file, receiving streamed file fragments from a network proxy and storing the fragments in the local storage as the fragments arrive, wherein the local storage is connected to the mobile device via a bus interface; and
managing access by the mobile device to the partly or completely downloaded file contingent upon the notification.

38. The method according to claim 37, wherein said awaiting further comprises receiving address and signing information that enables direct receipt of the notification from the malware scanning server.

39. The method according to claim 38, wherein, upon receipt of a malware absence notification, managing access by the mobile device further comprises granting the mobile device access to the file stored in the local storage.

40. The method according to claim 38, wherein, upon receipt of a malware presence notification, managing access by the mobile device further comprises denying the mobile device access to the file.

41. The method according to claim 37, wherein said awaiting comprising receiving from the network proxy a second notification contingent upon a first notification to the network access module, the second notification comprising instructions to be executed for managing access by the mobile device.

42. The method according to claim 41, wherein, upon receipt of a malware absence notification, the second notification comprises instructions to grant the mobile device access to the file stored in the local storage.

43. The method according to claim 41, wherein, upon receipt of a malware presence notification, the second notification comprises instructions to deny the mobile device access to the file.

44. An autonomous network access module comprised within a mobile device, and comprising a local storage, a radio transceiver and a processing unit, connected to the mobile device via a bus interface, adapted and configured to:
receive and intercept, from a main processing unit comprised in the mobile device, a request to a network for a file;
instruct a network proxy to request streaming of the file from a remote web server on behalf of the network access module;
instruct the network proxy to concurrently stream the file to the network access module and to a malware scanning server in the network;
receive streamed file fragments from the network proxy and store the fragments in the local storage as the fragments arrive, wherein the local storage is connected to the mobile device via a bus interface;
await a notification based on an outcome of the malware scanner server scanning the file; and
manage access by the mobile device over said bus interface to the partly or completely downloaded file contingent upon the notification.

45. The network access module according to claim 44, further adapted and configured to receive address and signing information enabling direct receipt of the notification from the malware scanning server while awaiting the notification.

46. The network access module according to claim 44, adapted and configured to manage access by, upon malware absence notification, granting the mobile device access to the file stored in the local storage,.

47. The network access module according to claim 44, adapted and configured to manage access by, upon malware presence notification, denying the mobile device access to the file.

48. The network access module according to claim 44, further adapted and configured to:
receive from the network proxy a second notification contingent upon a first notification to the network access module, the second notification comprising instructions to be executed for managing access by the mobile device; and
execute the received instructions.

49. The network access module according to claim 48, wherein the second notification comprises instructions to grant the mobile device access to the file stored in the local storage upon receipt of malware presence.

50. The network access module according to claim 48, wherein the second notification comprises instructions to deny the mobile device access to the file.

51. A network proxy for an autonomous network access module having a local storage connected to a mobile device via a bus interface, wherein the network proxy comprises a first radio network interface and transceiver, a second network interface towards the Internet, a memory and a processing unit, adapted and configured to:
receive and intercept, from a main processing unit comprised in the mobile device, a request to a network for a file;
request streaming of the file from a remote web server on behalf of the network access module of the mobile device;
concurrently stream the received streamed file to the network access module and to a malware scanning server on behalf of the network access module;
arrange for the network access module to receive a notification based on an outcome of the malware scanning server scanning the file; and
arrange for managing access by the mobile device to the partly or completely downloaded file contingent upon the received notification.

52. The network proxy according to claim 51, further adapted and configured to:
send a malware scanning server address and signing details to the network access module; and
instruct the malware scanning server to notify the network access module directly.

53. The network proxy according to claim 51, further adapted and configured to:
receive a first notification from the malware scanning server;
send a second notification contingent upon the first notification to the network access module, the second notification comprising instructions to be executed for managing access by the mobile device; and
execute the received instructions.

54. An autonomous network access module comprised within a mobile device, and comprising a local storage, a radio transceiver and a processing unit, connected to the mobile device via a bus interface, adapted and configured to:
receive a request for a file from a main processing unit comprised in the mobile device and forward the request;
receive streamed file fragments from a network proxy and store the fragments in the local storage as the fragments arrive;
await a notification based on an outcome of a malware scanning server scanning the file; and
manage access by the mobile device to the partly or completely downloaded file contingent upon the notification.

55. The network access module according to claim 54, further adapted and configured to receive address and signing information enabling direct receipt of the notification from the malware scanning server while awaiting the notification.

56. The network access module according to claim 54, further adapted and configured to:
receive from the network proxy a second notification contingent upon a first notification to the network access module, the second notification comprising instructions to be executed for managing access by the mobile device; and
execute the received instructions.

57. The network access module according to claim 56, wherein the second notification comprises instructions to grant the mobile device access to the file stored in the local storage upon receipt of malware presence.

58. The network access module according to claim 56, wherein the second notification comprises instructions to deny the mobile device access to the file.

59. A computer program product stored on a computer readable medium and comprising program code that, when executed by a processing unit associated with an autonomous network access module comprised within a mobile device, cause the network access module to:
receive and intercept, from a main processing unit comprised in the mobile device, a request to a network for a file;
instruct a network proxy to request streaming of the file from a remote web server on behalf of the network access module;
instruct the network proxy to concurrently stream the file to the network access module and to a malware scanning server in the network;
receive streamed file fragments from the network proxy and store the fragments in a local storage as the fragments arrive, wherein the local storage is comprised in the network access module and is connected to the mobile device via a bus interface;
await a notification based on an outcome of the malware scanner server scanning the file; and
manage access by the mobile device over said bus interface to the partly or completely downloaded file contingent upon the notification.

60. A computer program product stored on a computer readable medium and comprising program code that, when executed by a processing unit associated with an autonomous network access module comprised within a mobile device, cause the network access module to:
receive a request for a file from a main processing unit comprised in the mobile device and forward the request;
receive streamed file fragments from a network proxy and store the fragments in a local storage as the fragments arrive, wherein the local storage is comprised in the network access module and is connected to the mobile device via a bus interface;
await a notification based on an outcome of a malware scanning server scanning the file; and
manage access by the mobile device to the partly or completely downloaded file contingent upon the notification.

61. A computer program product stored on a computer readable medium and comprising program code that, when executed by a processing unit associated with a network proxy for an autonomous network access module of a mobile device, cause the network proxy to:
receive and intercept, from a main processing unit comprised in the mobile device, a request to a network for a file;
request streaming of the file from a remote web server on behalf of the network access module of the mobile device;
concurrently stream the received streamed file to the network access module and to a malware scanning server on behalf of the network access module;
arrange for the network access module to receive a notification based on an outcome of the malware scanning server scanning the file; and
arrange for managing access by the mobile device to the partly or completely downloaded file contingent upon the received notification.
